(19) United States
(12) Patent Application Publication
(10) Pub. No.: US 2013/0054381 A1
(43) Pub. Date: Feb. 28, 2013

(54) Method Of Selling And Producing A Customized Product

(71) Applicant: Todd Richheimer, Bayside, WI (US)

(72) Inventor: Todd Richheimer, Bayside, WI (US)

(21) Appl. No.: 13/596,809

(22) Filed: Aug. 28, 2012

Related U.S. Application Data
(60) Provisional application No. 61/528,417, filed on Aug. 29, 2011.

(51) Int. Cl. G06Q 30/06; G06Q 30/02

(52) U.S. Cl. 705/14.73; 705/14.4

(57) ABSTRACT

A method for selling and producing a customizable product, e.g., a t-shirt, is provided. The method may be preferably implemented on the Internet. A third party seller uploads a design or may create a new design on an Internet website. In addition, the seller provides a time period for selling limitation, a minimum order requirement and a desired sell price based on costs. The product is advertised to customers and, if the number of product sold during the time period meets a minimum requirement, production is initiated. If the minimum requirement is not met upon the expiration of the time period, all pending orders are cancelled.

### CROSS-REFERENCE TO RELATED APPLICATION

This application claims priority from U.S. Provisional Patent Application Ser. No. 61/528,417 filed on Aug. 29, 2011, the entirety of which is expressly incorporated by reference herein.

### FIELD OF THE INVENTION

This invention relates generally to a method for selling and producing products, and in particular, to a method for selling and producing customizable products which allows the seller to set minimum order requirements that must be met before production begins.

### BACKGROUND AND SUMMARY OF THE INVENTION

As can be appreciated, the Internet is an efficient and economical way for businesses to offer customized products to online users. The standard practice of selling customized products, such as t-shirts, is to pre-produce a certain volume of product, which is then sold to consumers. There are several disadvantages to this existing practice. First, the seller must invest capital in the production of the product, and therefore, bear the risk of failing to realize a return on the investment. As a result, it is highly possible that the seller will fail to sell enough of the product to recoup the investment. Second, if the seller fails to sell all of its product, the unsold product constitutes economic waste. Third, and more specifically to t-shirts and similar items that are available in different sizes, a seller will have to guess the quantity of various sizes to order, which again may result in unsold product and economic waste.

Therefore, it is a primary object and feature of the present invention to provide a method for selling and producing customizable products which allows a seller to set minimum order requirements that must be met before production begins.

It is a further object and feature of the present invention to provide method for selling and producing customizable products which is more efficient than prior methods.

It is a still further object and feature of the present invention to provide method for selling and producing customizable products which is simple to implement and limits the financial risk associated with the production of the products.

In accordance with the present invention, a method is provided for selling and producing a product. The method includes the steps of uploading criteria for the product to a webpage and selecting a minimum order requirement. The product is advertised in a user selected manner and orders for the product are collected. The product is produced in response to the number of orders collected being at least equal to the minimum order requirement.

The criteria includes a design for the product, which may be modified on a website associated with the webpage. In addition, a time limitation for collecting orders for the product may be selected. It is contemplated for payment for the orders be collected only if the minimum order requirement is satisfied.

In order to advertise the product in a user selected manner, the method contemplates selecting the manner of advertising the product and selecting the recipients for the advertising. The recipients may be selected by inputting potential customer email addresses into the webpage and sending emails to the potential customer email addresses. Alternatively, or additionally, the advertising may be posted on a social network or on a website associated with the webpage. Order data and statistics may be monitored via at least one of a website interface, a text message, and an email message.

In accordance with a further aspect of the present invention, a method is provided for selling and producing a customized product. the method includes the steps of receiving from a seller: 1) a design of the customized product to a database; 2) recipients of advertising for the customized product; 3) a manner of advertising for the customized product; 4) a minimum number requirement for the customized product; and 5) a time period for satisfying the minimum order requirement. The customized product is advertised in accordance with the manner of advertising selected. At least one order for the customized product is collected and each order includes a number of customized products to be purchase. The customized product is produced in response to the number of customized products to be purchased during the time period being at least equal to the minimum number requirement.

A first order of the at least one order may be collected from the seller. The number of custom products to be purchased in the first order may be at least equal to or a portion of the minimum number order requirement. Alternatively, the at least one order may be collected from the recipients of advertising. As such, the number of custom products to be purchased may be at least equal to the minimum number order requirement.

In accordance with a still further aspect of the present invention, a method is provided for selling a customizable product. The method includes the steps of receiving a design for a customizable product from a seller and calculating costs associated with the production of the customizable product in a desired quantity level. The seller also provides: 1) a set price for the customizable product; 2) a minimum number requirement associated with the customizable product; and 3) a time period during which the minimum number requirement must be met. The customizable product is advertised and offered for sale at the set price during the time period. Orders for the customizable product are received during the time period and each order includes a number of products to be purchased. The customizable products are produced if the number of products to purchased by the orders during the time period is at least equal to the minimum number requirement.

It is noted that the orders may be terminated if the number of products purchased is less than the minimum number requirement. Payment for orders is collected in response to production of the customizable product. It is contemplated for the customizable product to be a t-shirt and each t-shirt to have a size associated therewith. The seller may specify the total quantity of t-shirts to be produced and the sizes of the t-shirts to be produced. In addition, each order received may include the sizes and colors for each of the number of products to be purchased.

### BRIEF DESCRIPTION OF THE DRAWING

The drawing furnished herewith illustrates a preferred construction of the present invention in which the above advantages and features are clearly disclosed, as well as others which will be readily understood from the following description of the illustrated embodiment.

In the drawing:

FIG. 1 is a schematic, block diagram of a methodology in accordance with the present invention.

### DETAILED DESCRIPTION OF THE DRAWING

The inventive method of selling and producing a customized product is preferably implemented using the Internet. Accordingly, in one embodiment, an Internet website is used to effectuate the methodology of the present invention including, but not limited to the advertisement, sale, production, and/or delivery of a customized product. By way of example, in order to more clearly describe the present invention, the method will be discussed in the context of producing a customized t-shirt. However, the method is not limited to the production of t-shirts and may be used to produce any customizable product. Thus, a t-shirt is only one example of a customizable product that may be advertised, sold, produced, and delivered using the inventive method.

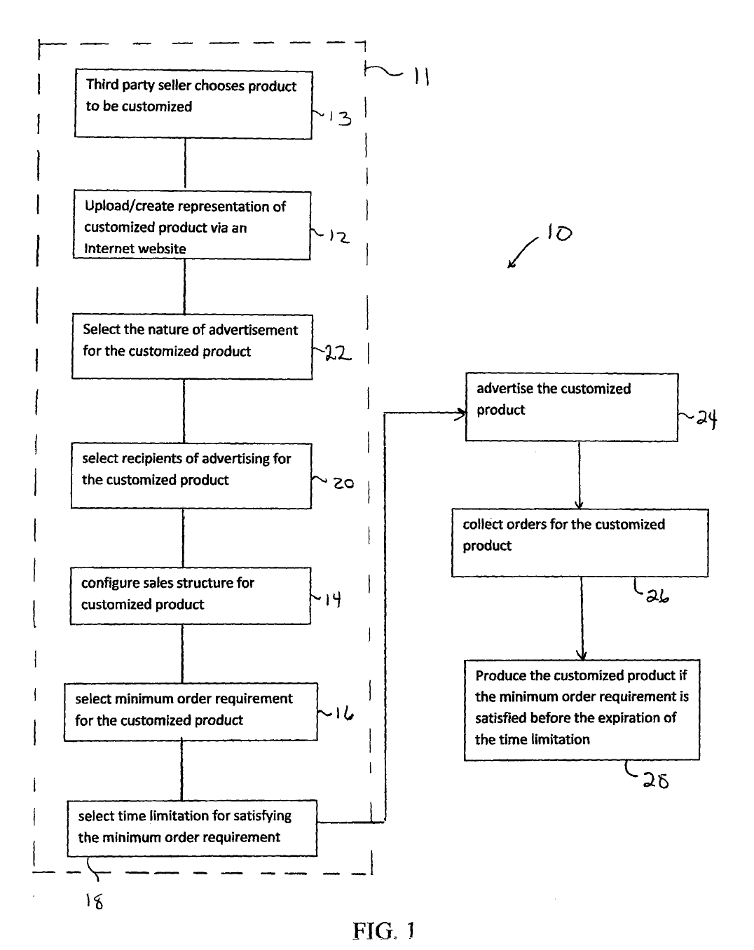

Referring to FIG. 1, a flow chart of the methodology of the present invention is generally designated by the reference numeral 10. Initially, it is contemplated for a user, such as a third party seller, to access a predetermined website. At the website, the third party seller is guided through a series of steps to set up an account. As is common with many Internet websites, the website used to implement the inventive method may include a secure account for each third party seller such that the secure account may only be accessed by the third party seller using unique login information, including a user name and password.

Once the account of the third party seller is set up, the third party seller is guided through an order process, generally designated by the reference numeral 11, by the website. Initially, the third party seller must choose the customizable product to be offered for sale, block 13. For example, the third party seller may be prompted to select a model number and/or color of the t-shirt to be designed. Alternatively, the third party seller may selected the style of t-shirt, e.g., a long sleeve t-shirt, a sleeveless t-shirt, etc., to be customized. Once the customized product has been selected, the artwork to be placed thereon is chosen.

In order place artwork on the customizable product, the third party seller may upload one or more t-shirt designs into an online art library associated with the third party seller's login information on the website, or in the alternative, design the t-shirt on the website in accordance with instructions provided on the website, block 12. It is contemplated that the website include various programs or features that enable the third party seller to design a t-shirt or to modify an existing design that has been uploaded to the website. For example, the website may include a database of various images that may be used to customize a t-shirt. In another example, the website may include a database of fonts, styles, borders, accents, or other images or design elements that may be used to design a t-shirt. At any time during the design process or upon completion of uploading the t-shirt design, the t-shirt design may be stored in a library or database associated with the third party seller's account. As such, the third party seller may access t-shirt designs previously uploaded or created by the third party seller by simply logging into the third party seller's account.

After the third party seller has finalized the design of the t-shirt, the third party seller determines the nature of the advertisement of the customized t-shirt, block 22. More specifically, the customized t-shirt may be advertised via the website or on third party websites. Further, the advertisement may sent directly to selected individuals via email, text or the like. The third party seller may select potential customers to receive the advertisements, e.g., themselves only; the general public; members of the website; members of a third party website; and/or third parties identified by the third party seller, block 20. It is further contemplated to limit the quantity of t-shirts that may be purchased by a third party, if so desired by the third party seller.

The third party seller must also determine the sales structure for the customized t-shirt, block 14. To do so, the website includes a program or feature for selecting from various options with respect to the processing of orders for the third party seller's customized t-shirt. For example, as a first option, the third party seller may elect to simply purchase a selected quantity of the customized t-shirts, which is similar to the existing practice where t-shirts are pre-produced and then sold. After purchase by the third party seller, the customized t-shirts will be produced and then shipped directly to the third party seller. As a second option, the third party seller may elect to purchase a minimum quantity of customized t-shirts sufficient to induce production of the customized t-shirts, as hereinafter described, as well as, allowing third party customers to purchase the customized t-shirts and individually receive them. As a third option, the third party seller may purchase the quantity of customized t-shirts to be produced, but in this instance, the customized t-shirts would be shipped directly to the third party customers individually who place orders via the website. The third party seller would then be reimbursed by the third party customers. As a fourth option, third party customers could purchase the t-shirts themselves directly from the website via the “marketplace”.

The website further includes a feature to enable the third party seller to calculate quantity levels and the costs associated with the production of such quantity levels, thus assisting the third party seller in determining the final sell price in order to maximize profit. Various data and statistics representing quantity levels and costs may be processed by the website and displayed to the third party seller via the website. Additionally, the data and statistics may be communicated to the third party seller by other means, such as by email or text message. The feature may provide real time data reflecting actual sales and costs of the third party seller's customized t-shirts. It is further contemplated that the website allow the third party seller to set the price for the customized t-shirt prior to the advertising and/or offering for sale of the customized t-shirt on the website. Once posted, the price cannot be changed unless sales of the customized t-shirt do not meet a minimum order requirement, as hereinafter described. In the event that the minimum order requirement is not met, the third party seller may report the customized t-shirt at a different times with different criteria, relating to pricing and the like.

As previously noted, the method of the present invention contemplates the third party seller setting a minimum order requirement that reflects the minimum number of orders that must be placed in order to produce the customized t-shirts and fulfill the orders, block 16. As hereinafter described, the customized t-shirts are advertised/offered for sale for a predetermined time period. If at the end of the predetermined time period, the minimum order requirement has been met, each customer is charged for their order in the manner selected by the third party seller, as heretofore described. The product, namely, the customized t-shirts, are produced and distributed based on the nature of the order, preferably within seven (7) business days. Alternatively, if the minimum order requirement is not satisfied, the customized t-shirts are not produced and the orders are canceled.

Further, as noted, the minimum order requirement may be constrained by a time limitation, block 18. In other words, if the minimum order requirement is not met within the time limitation (e.g., 1 day; 1 week; or 1 month), then the advertisement expires and orders for the customized t-shirt are no longer processed. Moreover, any pending orders are canceled if the minimum order requirement is not satisfied. Alternatively, if the minimum order requirement is satisfied within the time limitation, the payments are processed and the orders are fulfilled. Thus, it should be noted that the orders are not processed until after the time limitation has expired and the minimum order requirement is satisfied. Hence, when the customized t-shirts are produced after the expiration of the time limitation, there will be a single production run because no further orders can be placed. This arrangement, in turn, reduces the risk of over production of the customized t-shirt and is more cost effective for the third party seller. It is noted that the time limitation may be selected by the third party seller prior to the advertisement of the customized t-shirts. It can be appreciated that by having a minimum order requirement, profitability to both the third party seller and to the t-shirt producer may be assured. As is known, a threshold quantity of t-shirts must be sold in order for the t-shirt producer and the third party seller to realize a profit. The minimum order requirement preferably represents that profit threshold or a quantity above that profit threshold.

As discussed above, the third party seller has various options with respect to the parameters of the sale. When setting the parameters, the third party seller can choose to purchase the minimum order requirement, and therefore, ensure that the order will be processed. Alternatively, the third party seller can choose to rely upon customer orders, solely or in combination with their own purchase of less than the minimum order requirement, in order to fulfill the minimum order requirement, which is a riskier option because there is no guarantee that the minimum order requirement will be met. Failure to meet the minimum order requirement may result in customer disappointment if orders are canceled.

As another feature, the third party seller selects the format for collecting sizes and quantities of t-shirts. As a first option, the third party seller may choose the sizes and quantities of t-shirts. As a second option, the third party seller may choose the sizes and quantities of t-shirts for the minimum order requirement, and then permit the third party customers to select sizes and quantities for any orders placed above the minimum order requirement. As a third option, the third party seller may choose to allow the third party customers to choose their own size and quantities.

Once all of the criteria heretofore described for offering the customized t-shirt for sale have been completed/established, a summary is provided to the third party seller. The summary may include an image of the customized t-shirt; the nature of the advertisement of the customized t-shirt, including a list the potential customers identified by the third party seller to receive the advertisement; a statement specifying who will be responsible for payment for the customized t-shirts that are ordered; a desired method of shipment for the customized t-shirts ordered; pricing for the customized t-shirts; the sizes and quantities of customized t-shirts to be produced; and the time limitation for the placement of orders. Once the third party seller approves the summary provided, order process 11 is completed.

Once the third party seller has completed the order process 11, the customized t-shirts are advertised, block 24. These advertisements may include a posting on the website with an image of the t-shirt, as well as various website features that enable a customer to order the t-shirt. For example, as is common with many Internet websites, the website may have an interface that enables a customer to input the quantity and size(s) of the customized t-shirts to order, as well as to input payment and delivery information. The customer may further be able to customize the order, for example, by indicating what color t-shirt(s) are desired.

Another example of an advertisement includes posting advertisements on one or more third party websites. The third party items may be configured to collect the necessary information from a customer, e.g., quantity, size, color, delivery information, and/or payment information, and then transmit the information to the website for processing. Alternatively, the advertisement on the third party website may have a link directing the customer back to the website for collection of the information necessary to process an order.

A further example of advertising may include sending emails to potential customers. The third party seller may input email addresses into the website, which will generate an email advertisement for the third party seller's customized t-shirt. Alternatively, the website may include a program or feature enabling the third party seller to import contact information, e.g., email addresses, of potential customers. The advertisement emailed to the potential customers may feature the third party seller's customized t-shirt design and direct the potential customers to the website, e.g., via a link, to place an order. A still further example of advertising may include a network of potential customers that is created by the website. In other words, the third party seller's customized t-shirt design may be advertised to a network of people who have user accounts with the website. Another example of advertising may include the option for the third party seller to post an advertisement on other third party social networks such as Facebook, Google Plus, and Pinterest. The website may facilitate connection to various third party social networks. An advertisement on a third party social network may include a link to the website so that a customer may place an order.

In response to the various advertisements heretofore described, orders for the customized t-shirt are received by the website, block 26. It is contemplated for the order to include a quantity of customized t-shirts to be purchased and the third party customers' payment information. As heretofore described, sales of the customized t-shirt may be monitored by the third party seller via the third party seller's account. If the minimum order requirement is satisfied, and upon completion of the time limitation, the payments of the customers are processed and the orders are fulfilled, block 28.

Various modes of carrying out the invention are contemplated as being within the scope of the following claims particularly pointing out and distinctly claiming the subject matter, which is regarded as the invention.

I claim:

1. A method for selling and producing a product, comprising the steps of:
uploading criteria for the product to a webpage;
selecting a minimum order requirement;
advertising the product in a user selected manner;
collecting orders for the product; and
producing the product in response to the number of orders collected being at least equal to the minimum order requirement.

2. The method of claim 1 wherein the criteria includes a design for the product, and wherein the method includes the additional step of modifying the design on a website associated with the webpage.

3. The method of claim 1 further comprising the step of selecting a time limitation for collecting orders for the product.

4. The method of claim 1 further comprising the step of collecting payment for the orders only if the minimum order requirement is satisfied.

5. The method of claim 1 wherein the step of advertising the product in a user selected manner includes the additional steps of:
selecting the manner of advertising the product; and
selecting the recipients for the advertising.

6. The method of claim 5 wherein the recipients are selected by inputting potential customer email addresses into the webpage and wherein the step of advertising the product includes the step sending emails to the potential customer email addresses.

7. The method of claim 5 wherein the manner of advertising includes posting the advertising on a social network.

8. The method of claim 5 wherein the manner of advertising includes posting advertising on a website associated with the webpage.

9. The method of claim 1 further comprising the step of monitoring order data and statistics via at least one of a website interface, a text message, and an email message.

10. A method for selling and producing a customized product, comprising the steps of:
receiving from a seller:
a design of the customized product to a database;
recipients of advertising for the customized product;
a manner of advertising for the customized product;
a minimum number requirement for the customized product; and
a time period for satisfying the minimum order requirement;
advertising the customized product in accordance with the manner of advertising selected;
collecting at least one order for the customized product, each order including a number of customized products to be purchased; and
producing the customized product in response to the number of customized products to be purchased during the time period being at least equal to the minimum number requirement.

11. The method of claim 10 wherein a first order of the at least one order is collected from the seller, the number of custom products to be purchased in the first order being at least equal to the minimum number order requirement.

12. The method of claim 10 wherein a first order of the at least one order is collected from the seller, the number of custom products to be purchased in the first order being at least a portion of the minimum number order requirement.

13. The method of claim 10 wherein the at least one order is collected from the recipients of advertising, the number of custom products to be purchased in the at least one order being at least equal to the minimum number order requirement.

14. A method for selling a customizable product comprising the steps of:
receiving a design for a customizable product from a seller;
calculating costs associated with the production of the customizable product in a desired quantity level;
receiving from the seller:
a set price for the customizable product;
a minimum number requirement associated with the customizable product; and
a time period during which the minimum number requirement must be met;
advertising the customizable product;
offering the customizable product for sale at the set price during the time period;
receiving orders for the customizable product during the time period, each order including a number of products to be purchased;
producing customizable products if the number of products to purchased by the orders during the time period is at least equal to the minimum number requirement.

15. The method of claim 14 comprising the additional steps of terminating the orders if the number of products purchased is less than the minimum number requirement.

16. The method of claim 14 further comprising the step of collecting payment for orders in response to production of the customizable product.

17. The method of claim 14 wherein the customizable product is a t-shirt, each t-shirt having a size associated therewith.

18. The method of claim 17 further comprising the additional step of receiving from the seller:
a total quantity of t-shirts to be produced; and
the sizes of the t-shirts to be produced.

19. The method of claim 17 wherein each order received includes the sizes for each of the number of products to be purchased.

20. The method of claim 17 wherein each order received includes colors for each of the number of products to be purchased.
